(19) United States
(12) Patent Application Publication
(10) Pub. No.: US 2024/0424572 A1
(43) Pub. Date: Dec. 26, 2024

(54) SYSTEMS AND METHODS FOR PROVIDING INERT ENVIRONMENTS FOR ADDITIVE MANUFACTURING AND PROCESSING

(71) Applicant: Desktop Metal, Inc., Burlington, MA (US)

(72) Inventors: George Hudelson, Billerica, MA (US); Emanuel M Sachs, Newton, MA (US); Jamison Go, Burlington, MA (US); Luke Jorgensen, Burlington, MA (US); John Reidy, Burlington, MA (US)

(73) Assignee: Desktop Metal, Inc., Burlington, MA (US)

(21) Appl. No.: 18/690,415

(22) PCT Filed: Sep. 13, 2022
(86) PCT No.: PCT/US2022/043339

§ 371 Date: Mar. 8, 2024

Related U.S. Application Data
(60) Provisional application No. 63/243,630, filed on Sep. 13, 2021.

(51) Int. Cl. B22F 12/70; B22F 12/20; B33Y 30/00; B33Y 40/00

(52) U.S. Cl. CPC B22F 12/70; B22F 12/20; B33Y 30/00; B33Y 40/00; B22F 2201/11

(57) ABSTRACT

Systems and methods for providing inert manufacturing and processing environments. In certain embodiments, a build box having green parts that were manufactured via binder jetting additive manufacturing is sealed with a lid and heat cured in an oven. A supply of process gas is delivered to the build box to provide an inert environment within the build box during the heating process, which results in an exhaust of gaseous species from the build box and prevents contamination from the ambient environment. In certain embodiments, copper-alloy parts are manufactured via binder jetting additive manufacturing in an inert environment to achieve higher final densities after post-processing and sintering.

### PRIOR APPLICATION

This application claims the benefit under 35 U.S.C. §119(e) of U.S. Provisional Application No. 63/243,630 filed Sep. 13, 2021, the entire contents of which are herein incorporated by reference.

### TECHNICAL FIELD

The present disclosure relates generally to additive manufacturing and more specifically to providing inert environments for additive manufacturing processes.

### BACKGROUND OF THE DISCLOSURE

The atmosphere in which metal objects are manufactured and processed can substantially affect the resultant product. A disadvantageous atmosphere can lead to part defects and undesirable material properties. Therefore, efforts have been made to provide suitable atmospheric environments during manufacturing and processing, such as providing an inert atmosphere, providing a vacuum, etc. However, these solutions are costly and ultimately uneconomical in certain circumstances. In additive manufacturing, there remains a need for systems and methods for providing inert manufacturing and processing environments.

### SUMMARY OF THE DISCLOSURE

Disclosed now are systems and methods for providing inert manufacturing and processing environments. In certain embodiments, a build box having green parts that were manufactured via binder jetting additive manufacturing is sealed with a lid and heat cured in an oven. A supply of process gas is delivered to the build box to provide an inert environment within the build box during the heating process, which results in an exhaust of gaseous species from the build box and prevents contamination from the ambient environment. In certain embodiments, copper-alloy parts are manufactured via binder jetting additive manufacturing in an inert environment to achieve higher final densities after post-processing and sintering.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a component schematic diagram of a binder jetting printer for use with embodiments of the present disclosure.

FIG. 2 depicts a cutaway view of the binder jetting printer of FIG. 1.

FIG. 3 depicts a first embodiment build box processing unit as employed in an oven.

FIG. 4 depicts a first embodiment build box processing unit as employed in an oven.

FIG. 5 depicts an embodiment build box for use in embodiments of the present disclosure.

FIGS. 6A-D depict an embodiment lid for use in embodiments of the present disclosure.

FIG. 7 is a chart of densities in copper-rich alloys manufactured via binder jetting in different environments.

### DETAILED DESCRIPTION

Disclosed below are systems and methods for providing inert environments for additively manufacturing and processing.

However, first described are systems and methods for manufacturing parts through powder bed binder jetting. Powder bed binder jetting involves spreading successive layers of a loose build material powder and jetting predetermined patterns of binder to form a three-dimensional part of bound build material. Objects manufactured by this process are then heat cured and sintered to densify the build material powder into densified objects.

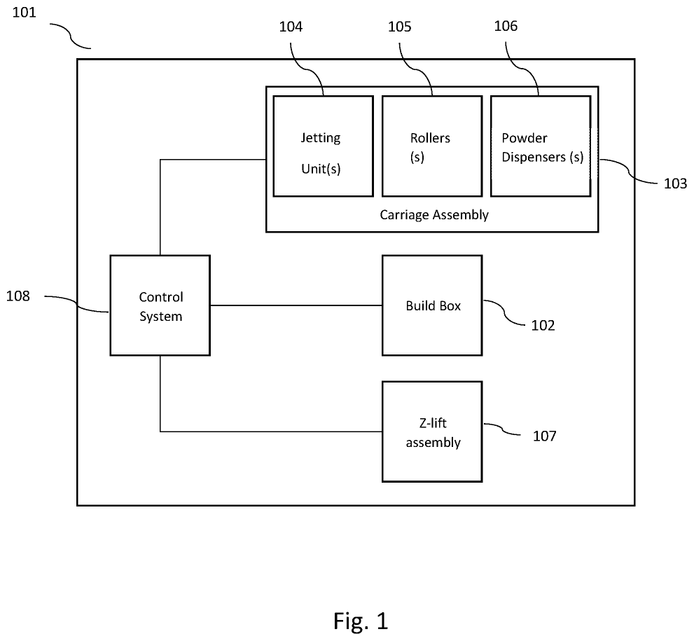

An exemplary binder jetting additive manufacturing system which may be used to manufacture parts for the disclosed assemblies is now described. With reference to FIG. 1, a binder jetting printer 101 includes a build box 102 where a part is to be manufactured. A carriage assembly 103 is moved relative to the build box 102 to deposit successive layers of build material powder and binder to form green parts. In certain embodiments, the binder jetting printer 101 can be used to manufacture metal parts. In these instances, the build material powder is metal powder, and the part is later sintered to densify the part. The carriage assembly includes jetting unit(s) 104 for depositing binder, roller(s) 105 for spreading powder layers prior to binder jetting and powder dispenser(s) 106 which meter build material powder for successively printed layers. In alternate embodiments, build material powder may be metered from elevators and spread across the build box. In the embodiment of FIG. 1, the printer 101 includes a Z-lift assembly 107 which moves a build platen with the build box down as successive layers are printed. The build platen may be considered as part of the build box and be removed with it following printing for further processing. A control system 108 controls the various elements of the binder jetting printer 101.

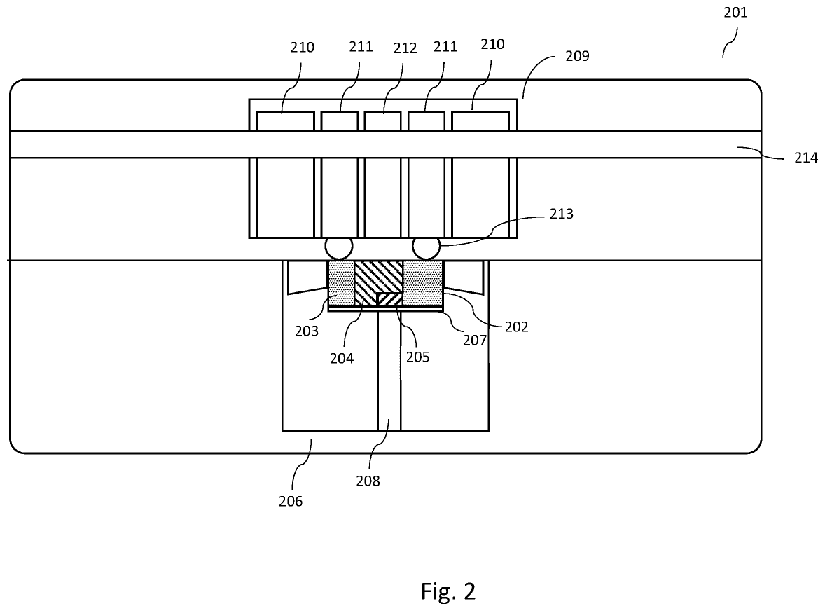

FIG. 2 depicts a side cutaway view of a binder jetting printer 201. A build box 202 contains loose powder 203 and a part 204 being manufactured and potentially support structures 205. A Z-lift assembly 206 is configured to raise and lower the build box 202 and build platen 207 to facilitate the printing process. A lift 208 raises and lowers the build platen 207. A print carriage 209 traverses relative to the build box. In the depicted embodiment, the carriage 209 moves while the build box 202 is maintained in a static position, though the build box 202 could alternatively move while the carriage 209 is maintained in a static position. In the depicted embodiment, the carriage 209 includes an arrangement of components for use in jetting. In the embodiment, printing is bi-directional, i.e., in a first direction-left to right with reference to the figure, and then from right to left. To facilitate bi-directional printing, the depicted carriage 209 includes powder dispensing units 210, steamer units 211, a jetting unit 212 and roller units 213.

The printing area of the binder jetting printer 201 includes at least the build box and areas where build material powder is deposited or is likely to accumulate. Preferably, the Z-lift assembly is gaseously isolated from the printing area. In addition, the printing area is gaseously isolated from an ambient environment. In embodiment printing cycles, the printing area may first be purged using a relatively high flow rate of process gas. Thereafter, during a printing cycle in which a green part is manufactured a relatively lower flow rate of process gas may be employed to maintain a higher pressure of the process gas than the ambient environment such that flow of gaseous species from the ambient environment into the printing area is prevented and an inert environment is maintained. The flow of process gas may be collected and filtered and then recycled to reduce the overall need for fresh process gas.

For many materials, it is desirable to maintain an inert environment during steps of the binder jetting process, such as during the heating/curing step which occurs after printing. In this application, inert means having a reduced concentration of oxygen relative to the concentration of oxygen in air. This may prevent combustion or decomposition of the binder, oxidation of the powder, or in some cases may be required to avoid explosion or combustion of reactive powder materials. In certain embodiments, it may be desirable to maintain an inert environment around or slightly above at what may be considered room temperature (e.g., between 15 and 50 degree Celsius). Such a range of temperature or temperatures may prevail during some stages of a binder jetting process, or may also prevail between steps of a binder jetting process or even during the storage of parts and components utilized during the binder jetting process.

In some embodiments, it may be desirable to perform a heating step in an oven which is not inerted, or an oven that is not sufficiently inerted to prevent oxidation, binder combustion or the like (e.g. an air oven or a convection oven where the atmosphere in conjunction with other processing conditions may deleteriously affect materials or processes relating to binder jetting). For example, the cost and complexity of an air oven may be much lower than a comparable oven which can be inerted to a desirable level. To enable use of such an air oven, a system may be used wherein a build box containing printed parts and powder may be sealed and provided with inert gas such that it is isolated from the atmosphere of the oven. During the heating process, vapor (for example, water vapor, or other solvents) or other byproducts of a curing process may be evolved or produced, which may be desired to remove from the build box. In some embodiments, the removal of vapors or byproducts may be the rate-limiting step for curing to complete. For example, the presence of water vapor may inhibit a crosslinking reaction during binder curing, preventing the development of strength in printed parts until the concentration of water vapor is sufficiently low. In other embodiments, solvent or other vapors may similarly inhibit crosslinking or other strengthening or curing reactions, as will be understood by one of ordinary skill in the art. Removal of these vapors may be achieved by providing an exhaust path from the build box. The exhaust may be designed with a check valve or with a sufficiently long exhaust path such that the flow rate of effluent prevents an inward flow of air or oxygen from the oven environment. Expanding upon the action of a flow rate of effluent in an exhaust path, the flow rate of effluent (understood here to be volumetric, as in volume of gas per time) may be converted to a velocity of flowing effluent by dividing the flow rate of effluent by a representative cross section of the exhaust path. In the case of a cylindrical tube of length L and diameter D, the cross section is the circular cross section is pi/4*D, for example. The action of the effluent flow counteracts the migratory action of gaseous species which is typically characterized by a diffusion constant of what may be considered as a contaminant (such as oxygen, a vapor such as water, or any other gaseous species which is not desired to be present in the process). It has generally been found that the dimensionless combination of velocity of flowing effluent (defined as the variable u), the diffusivity of the gaseous contaminant (defined as the variable D), and the length of the effluent tube (defined as the variable L) should exceed u*L/D>25 to provide a robust degree of inerting. Here, the combination u*L/D is defined as the Peclet number, and is often denoted as “Pe”. In certain embodiments, the value of Pe may be as small as 1, while in others the value of Pe may be required to exceed 30. For purposes of clarity, considering an inerted process chamber with concentration of contaminants c0 into which a process gas flows and out of which an effluent gas flows, and a non-inerted surrounding with concentration of contaminants c1, and further supposing that a tube of length L through which an effluent gas flows (directed from c0 to c1) at a face velocity u, and the contaminants having a diffusivity D, an approximate form for the ratio of concentrations between c0 and c1 is given by c0/c1=exp(−Pe), where exp(x) is the exponential function of the argument x. As will be appreciated by one skilled in the art, the inflow of process gas and outflow of effluent gas will be identical (or nearly identical) during steady state operation; further, the process gas is understood to be free of contaminants, or at least exhibiting a low concentration of gaseous contaminants as compared to the level of gaseous contaminants required in the inerted process. Using this expression, c0/c1=exp(−Pe), parameters such as the known characteristics of an exhaust path (length and cross-section), diffusivity of the gaseous contaminant, required concentration in the process chamber and known concentration of non-inerted atmosphere (e.g., air oven), the flow rate required to produce the inerted process atmosphere is straightforward to calculate. As one skilled in the art will appreciate, as long as all but one of the system parameters are known, the last may be computed.

Using this approach, multiple build boxes may be heated inside a single oven. In some embodiments, build boxes may be added or removed without exposing the build boxes to air, which may not be possible using an oven with an inert atmosphere.

In certain embodiments, the gas supply to the build box may be provided at a high pressure sufficient to cause flow downward through the powder bed and out the bottom or sides of the build box. This may be advantageous as it may provide a forced convective effect causing the evolved vapor or products of curing to be evacuated from the build box at a higher rate than may happen ordinarily by natural convection or diffusion processes.

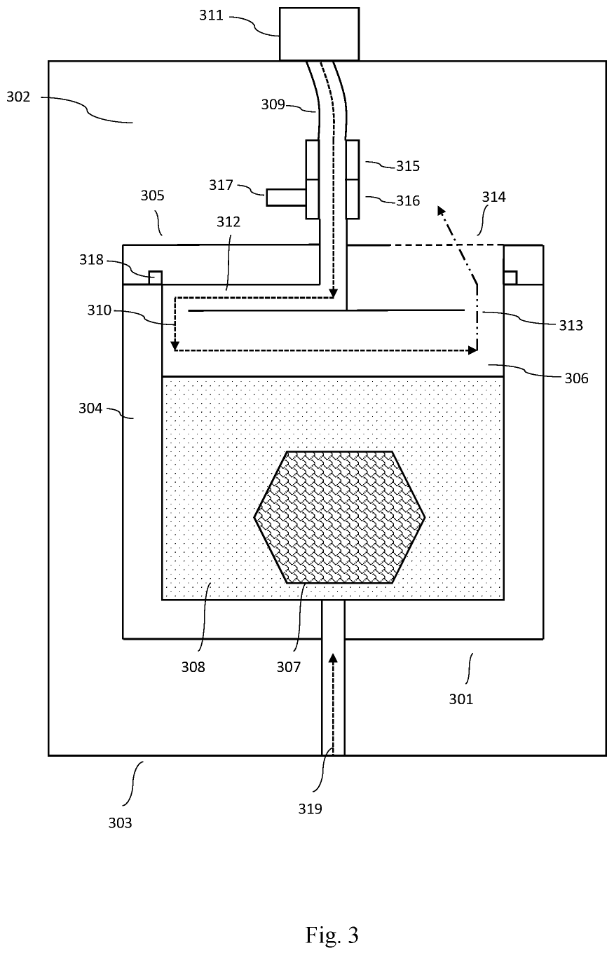

With reference now to FIG. 3, an embodiment build box 301 is disposed within a processing chamber 302 of an oven 303. The build box 301 has a body 304 and a lid 305. In FIG. 3 the build box 301 has in an interior 306 a part of bound build material powder 307 surrounded by unbound build material powder 308 as a result of a binder jetting additive manufacturing process as can be conducted with the printer of FIG. 2. The oven 303 may be any suitable oven such as a commonly available air oven which may or may not be capable of maintaining an inert environment, so long as it is capable of conducting a heating process to cure the part 307. A gas line 309 is configured to deliver a flow of process gas 310 to the interior 306 from a gas source 311 during a heating process. The flow of process gas is distributed by a distribution plenum 312. The distribution plenum 312 may comprise a baffle or other feature disposed to prevent direct impingement of the process gas 310 onto the surface of the bound build material powder 307 or unbound build material powder 308, which could blow or otherwise disturb build material powder on the surface. The process gas flows over the contents of the build box 301 as a sweep gas and removes evaporated species such as moisture and other binder solvents and is expelled as an outflow of exhaust gas 313 from a gas outlet 314 while providing an inert environment in the interior 306. A gas connector 315 connects the gas line 309 to an inlet connector 316 of the lid 305. The inlet connector 316 may have a pressure relief valve 317. The pressure relief valve 317 may function to prevent the pressure of gas inside the build box 301 from exceeding a predetermined maximum pressure which could cause mechanical failure of the build box 301. The lid 305 of the build box is sealed to the body 304 of the build box by gaskets 318. The expelled exhaust gas 313 may be expelled directly into the processing chamber 302 of the oven 303 which has an ambient processing environment. For the purposes of the present disclosure, an ambient processing environment should be understood to be the environment within the oven during use. This may initially in a heating cycle be ambient air but may come to include any exhausted species or other outgassed species inherent in the heating cycle within the associated oven. Optionally, an addition flow of process gas 319 may be provided upward through the bottom of the build box 301 during printing to keep an inert environment for part 307. Typically, heating cycles for curing parts in such ovens range from room temperature to 250° C. Heating cycles may comprise a single ramp rate from a starting temperature (for example, room temperature) up to a maximum temperature (for example, 200° C.) at a consistent heating rate, such as 1° C. per minute, followed by holding at peak temperature for a hold duration (for example, 8 hours), followed by cooling to room temperature. In other embodiments, heating cycles may include hold times at several temperatures. As an example, a two-step heating cycle may include a ramp from room temperature to a first hold temperature for a first time (for example, 90° C. for 4 hours), followed by heating to a second hold temperature for a second time (for example, 200° C. for 8 hours). The first temperature and second temperature may be selected to enhance the evaporation rate of water or other solvents, without exceeding the boiling temperature of the binder, which could induce cracking or other defects within the parts. As will be understood by one of ordinary skill in the art, the temperatures, ramp rates, and hold times will depend upon the composition of the binder in use, as well as the size of the build box; and may be determined experimentally or by means of modelling.

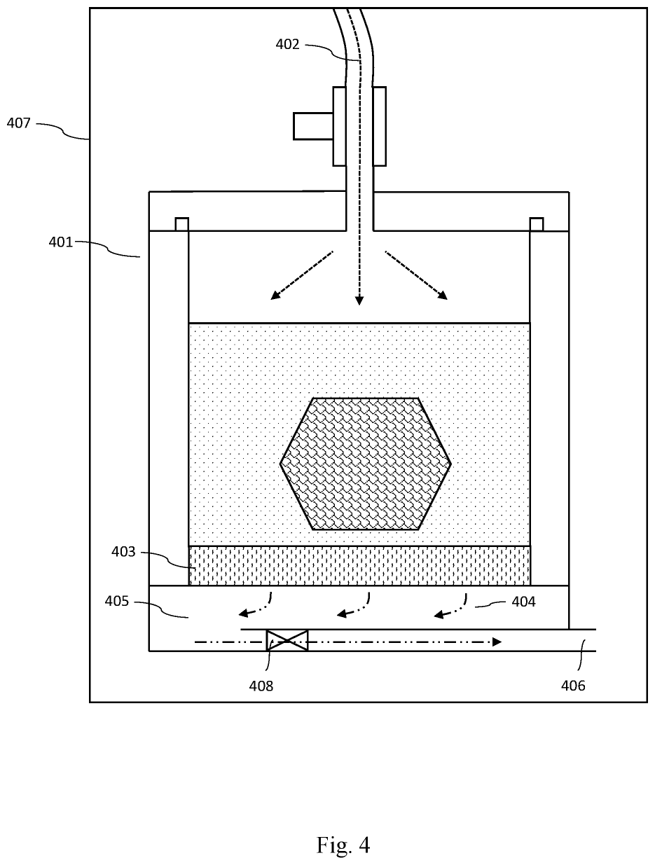

With reference now to FIG. 4, a second embodiment build box 401 is similar in most respects to the build box 301 of FIG. 3. However, a flow of progress gas 402 is provided to the build box 402 which creates a pressurization that forces the flow of process gas 402 through the contents of the build box 402 and through a bottom 403 of the build box 402 that has a higher porosity than the remainder of the build box 402. The bottom 403 of the build box 402 may for example be a mesh that does not permit transport of build material powder but allows gas flow. An exhaust gas flow 404 exits the build box 401 into an exhaust plenum 405 and through an outlet tube 406, which may vent into the oven 407 or to an exterior environment or filter device. The outlet tube 406 may have a length-to average-cross-section area ratio that, in conjunction with the outflow of the exhaust gas flow 404, substantially prevents a backflow through the outlet tube. This is referred to herein as a Peclet seal (the theory of which is described in detail above). A valve 408 such as a check valve may alternatively or additionally provide prevention of backflow of exhaust gas flow 404. It should be noted that the solution of FIG. 3 may employ a Peclet seal as described with FIG. 4 at an outlet to prevent backflow of the exhaust gas flow.

One advantage of the described build boxes is that, in inerting the interior of the build boxes, the air oven may be flushed with ambient air at a high rate during cooling while the parts inside the build boxes do not suffer degradation due to exposure to ambient air or oxygen. If the environment within the oven had to be maintained as inert, such flushing would require a cost prohibitive amount of process gas, or a complex heat exchanger setup for removing heat from recycled process gas.

In the present disclosure the term process gas refers to an inert gas such as argon or nitrogen. For the purposes of the present disclosure, an inert environment is defined as one with a sufficiently lower concentration of oxygen than ambient air to prevent adverse effects such as oxidation of powder, combustion or oxidation of binder, or sufficient oxygen to sustain combustion or explosion of powder. As will be understood by one of ordinary skill in the art, the level of oxygen required to provide an inert environment may vary based on the build material powder, binder, temperature, or other factors inherent in the printing process. During a printing process, an inert environment may be considered to be less than 5% oxygen, or more preferably less than 2% oxygen. During a curing or crosslinking process, a typical inert environment may have less than 1% oxygen, or more preferably less than 1000 parts per million (ppm), or even more preferably less than 100 ppm. Gasses other than argon or nitrogen may be used to provide an inert environment, such as carbon dioxide, helium, or any other gas which is known not to react or otherwise interact with the powder or binder. Additionally, mixtures of gasses may be used.

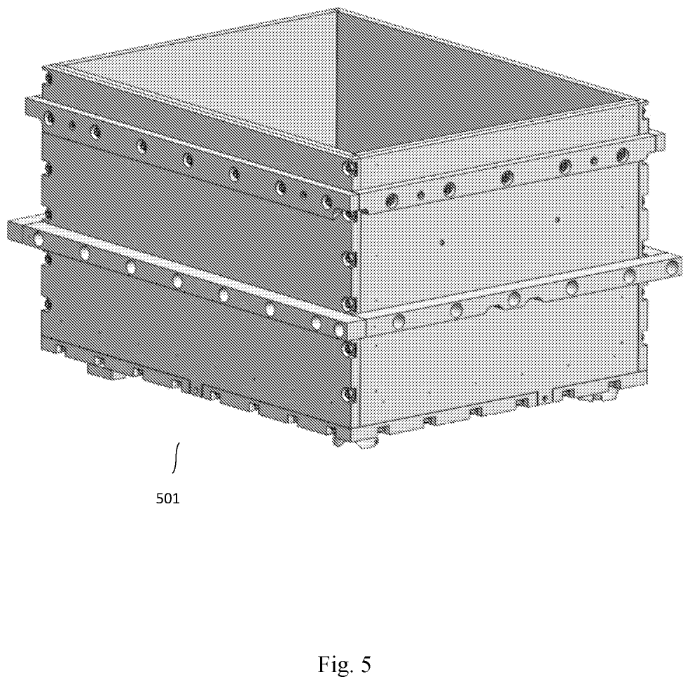

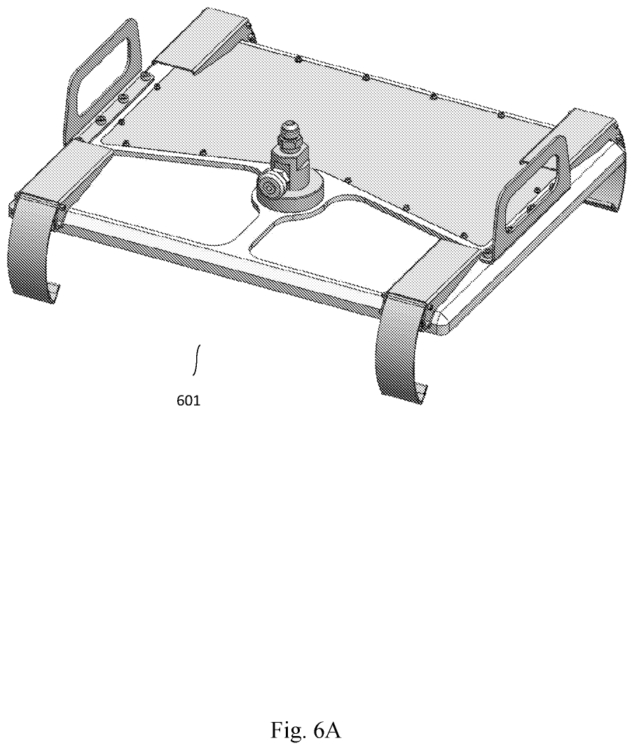

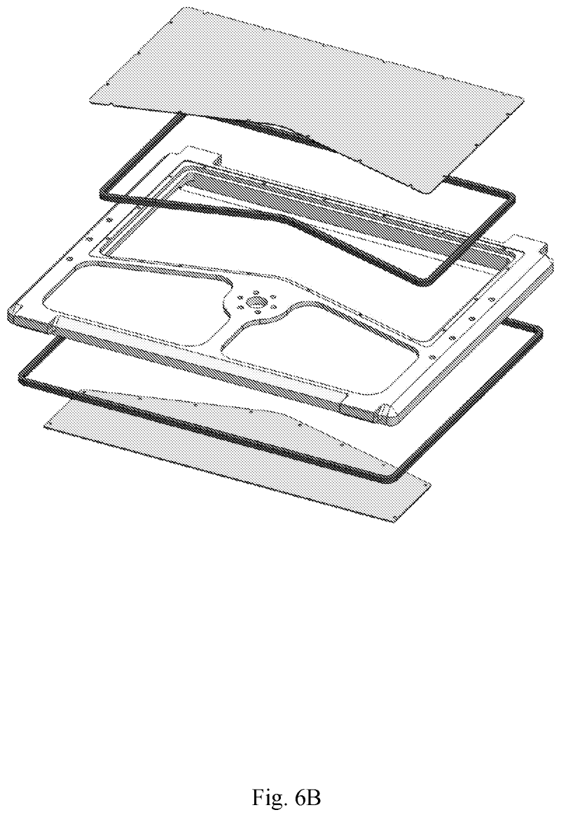

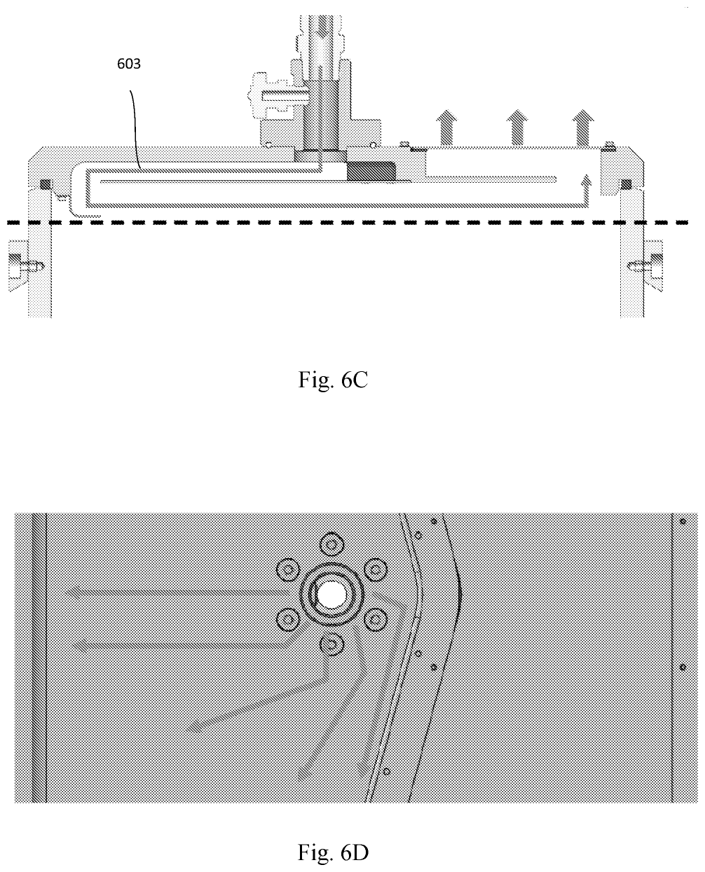

FIG. 5 depicts an embodiment build box 501 for use in the above-described methods. FIG. 6A depicts an embodiment lid 601 for use in the above-described methods. FIG. 6B is an exploded view of lid 601. FIGS. 6C-D depict a flow of process gas 603 through the embodiment lid 601.

Described now is a process in which a metal powder that is non-explosible and readily oxidized is printed using a binder jetting process (in keeping with FIG. 2) with an aqueous binder in an inert atmosphere. The binder jet printed parts are then subjected to a debind step in either air, or an inert atmosphere, or a reducing atmosphere (such as H₂), or vacuum. Then the part is subjected to a final sintering step to consolidate the part into a solid metal component.

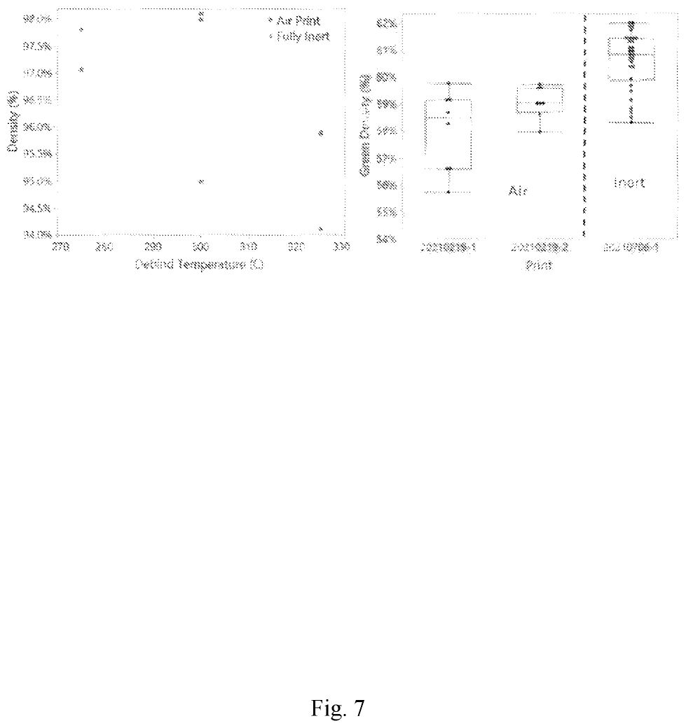

Copper-rich alloys binder jetting printed in an inert atmosphere achieve higher sintered density than copper parts printed in air, when both sets of parts are subsequently processed using the same debind and sinter cycle. For the purposes of the present disclosure, a copper-rich alloy should be understood to be one containing at least 98% copper. For example, commercially pure copper may be considered to contain at least 99.9% copper, while certain alloys of copper, chromium, and zirconium may contain approximately 98.5% copper. FIG. 7 the green density of parts printed using the same powder and process parameters in air were lower than the parts printed in an inert (N2 atmosphere with <2% O₂) atmosphere (59% of theoretical density for parts printed in air compared to 61% of theoretical density for parts printed in an inert atmosphere). In addition to green densities, FIG. 7 shows shows the final sintered density of copper parts printed in air and an inert environment, using several different air debind temperatures and sintered in the same cycle. Parts printed in air achieve 95% density at best, while parts printed in an inert atmosphere achieve as high as 98% density after sintering. Therefore, inert printing of copper enables high sintered density that cannot be achieved with parts printed in air.

This result is unexpected because the copper oxide can be reduced temperatures below the onset of densification in the sinter cycle with the use of a reducing atmosphere. Therefore, oxides that form during the printing process should be reduced in the sintering cycle before they are able to inhibit densification. Additionally, the parts tested are subjected to an air debind, which would be expected to add much more oxide to the copper than the printing process due to elevated temperature (250-325° C.) used in the debind process. After air debinding, the oxygen content is measured at ˜3.0 wt %, while the oxygen content measured in parts printed in air (prior to air debind) is <0.5 wt %. It is also not obvious that copper should be printed in an inert environment because the copper powder used is non-explosible. The copper powder, then, did not pose any safety risk for binder jet printing in air and did not necessitate the use of an inert atmosphere for printing. In some embodiments, printing at higher humidity (for example, greater than 50% relative humidity) may be desirable in some cases due to the impact of humidity on powder behavior. For example, copper powder stored at low humidity may have a cohesion which is too low (i.e. too flowable) to use in some binder jet printing systems. Thus, controlling to a high humidity may enable improved printing performance. However, high humidity in the presence of oxygen may lead to enhanced oxidation or corrosion of copper powder, why may lead to changes in cohesion and wettability by the binder over time. High humidity in the absence of oxygen (i.e. in an inerted environment) may limit the oxidation or corrosion of metal powders.

Oxidation of the powder during printing in air was observed by noting the change in color of powder that deposited in a pool of binder from orange to green. During prints conducted in air, it was also noted that, if the print paused for some time, the printed regions were observed to peel up from the bed compared to the unprinted areas. It is submitted that application of the binder onto the powder in air results in some oxidation, which preferentially forms at the layers in the part, resulting in interlayer porosity after sintering. Printing in an inert (nitrogen, argon, or the like) environment prevents this oxidation of the powder and enables the higher sintered densities shown in FIG. 7.

The benefit of printing in an inert atmosphere observed with copper is submitted to also be present in alloys that have oxides which can easily be reduced and which form at room temperature in the presence of air and an aqueous binder. Examples of these materials include: copper rich alloys such as brass, bronze, and monel; silver alloys; gold alloys containing silver and/or copper; and mixed powders (not pre-alloyed) containing iron and/or copper.

Copper alloys printed in an inert environment may typically be printed at or near room temperature (approximately 15-50° C.), and may be printed with a relative humidity between 20% and 80%. In some embodiments it may be preferrable to maintain a high humidity, for example 60-70%. Curing conditions for copper alloys may depend on the binder being used, but may typically be performed at approximately 200° C. Sintering for copper and copper alloys may depend on the alloy being used but may typically be performed at temperatures in the range of 800-1070° C.

An embodiment method of additively manufacturing parts, includes:
inerting a printing space of a binder jetting additive manufacturing system;
conducting a binder jetting additive manufacturing cycle to build a green part in a build box by successively depositing a build material powder and jetting patterns of binder; and
wherein the build material powder is a copper-rich alloy.

The method may further include wherein the inerting includes providing an atmosphere of an inert gas at a concentration such that the amount of oxygen is <2%.

The method may further include wherein the inert gas is one of Nitrogen and Argon.

The method may further include wherein the copper-rich alloy is selected from the group consisting of brass, bronze, monel.

The method may further include the steps of:
removing the build box from the printing space; and
conducting an curing operation on the build box.

The method may further include de-powdering the green part and sintering the green part.

The method may further include wherein absent the step of inerting the printing space the green part would suffer oxidation above a maximum threshold.

Another embodiment method of additively manufacturing parts, includes:
disposing a build box in a printing space of a binder jetting additive manufacturing system;
providing a flow of process gas into the printing space sufficient to purge the printing space of contaminant gases;
conducting a binder jetting additive manufacturing cycle to build a green part by successively depositing a build material powder and jetting patterns of binder;
wherein during the binder jetting additive manufacturing cycle, delivering a flow process gas to the printing space sufficient to maintain an inert environment; and
wherein the build material powder is selected from the group consisting of copper, brass, bronze, monel, silver alloy, gold alloy, copper alloy and iron alloy.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure In this invention, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this invention, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It is intended that the specification and examples be considered as exemplary only.

What is claimed:

1. A method of providing an inert environment during a processing step, comprising:
disposing a build box in a processing chamber of an oven having an ambient processing environment, wherein the build box includes a build box body and a lid, wherein the build box body encompasses at least one part of bound build material powder and a body of unbound build material powder;
conducting a heating process in the processing chamber to cure the part;
during at least a portion of the heating process, delivering a flow of process gas to an interior of the build box sufficient to provide an inert environment within the interior of the build box and cause an outflow of exhaust from the build box; and
wherein the flow of process gas is delivered to a top of the interior of the build box, via a distribution plenum including at least one baffle that prevents direct impingement of the body of unbound build material by the flow of process gas, and the outflow of exhaust flows through an exhaust outlet in the top of the build box.

2. The method of claim 1 wherein the exhaust outlet includes a valve preventing backflow.

3. The method of claim 1 wherein the exhaust outlet includes an outlet tube having a length-to average-cross-section area ratio that in conjunction with the outflow of the exhaust substantially prevents a backflow through the outlet tube.

4. The method of claim 1 further comprising the step of cooling the build box using a flow of ambient air over the build box.

5. A method of providing an inert environment during a processing step, comprising:
disposing a build box in a processing chamber of an oven having an ambient processing environment, wherein the build box includes a build box body and a lid, wherein the build box body encompasses at least one part of bound build material powder and a body of unbound build material powder;
conducting a heating process in the processing chamber to heat the part;
during at least a portion of the heating process, delivering a flow of process gas to an interior of the build box sufficient to provide an inert environment within the interior of the build box and cause an outflow of exhaust from the build box; and
wherein the flow of process gas is delivered to a top of the interior of the build box and at a pressure sufficiently high to cause the outflow of exhaust from a bottom of the build box body through an exhaust plenum, the bottom of the build box having a porosity sufficiently higher than a porosity of the remainder of the build box body to facilitate the outflow of exhaust from the bottom of the build box body.

6. The method of claim 5 wherein the exhaust plenum includes a valve preventing backflow.

7. The method of claim 5 wherein the exhaust plenum includes an outlet tube having a length-to average-cross-section area ratio that in conjunction with the outflow of the exhaust substantially prevents a backflow through the outlet tube.

8. The method of claim 5 further comprising the step of cooling the build box using a flow of ambient air over the build box.

9. A method of providing an inert environment during a processing step, comprising:
disposing a build box in a processing chamber of an oven having an ambient processing environment, wherein the build box includes a build box body and a lid, wherein the build box body encompasses at least one part of bound build material powder and a body of unbound build material powder;
conducting a heating process in the processing chamber to heat the part; and
during at least a portion of the heating process, delivering a flow of process gas to an interior of the build box sufficient to provide an inert environment within the interior of the build box and cause an outflow of exhaust from the build box.

10. The method of claim 1 wherein the flow of process gas is delivered to a top of the interior of the build box and at a pressure sufficiently high to cause the outflow of exhaust from a bottom of the build box body.

11. The method of claim 2 wherein the bottom of the build box body has a porosity sufficiently higher than a porosity of the remainder of the build box body to facilitate the outflow of exhaust from the bottom of the build box body.

12. The method of claim 1 wherein the flow of process gas is delivered to a top of the interior of the build box and the outflow of exhaust flows through an exhaust outlet.

13. The method of claim 4 wherein the exhaust outlet includes a valve preventing backflow.

14. The method of claim 5 wherein the exhaust outlet includes an outlet tube having a length-to average-cross-section area ratio that in conjunction with the outflow of the exhaust substantially prevents a backflow through the outlet tube.

15. The method of claim 1 further comprising the step of cooling the build box using a flow of ambient air over the build box.

16. A build box configuration for post-printing processing, comprising:
a build box having a build box body and a lid;
wherein the build box body encompasses at least one part of bound build material powder and a body of unbound build material powder;
a gas supply line connected to the lid of the build box and configured to deliver a flow of process gas to an interior of the build box, from a gas supply, sufficient to provide an inert environment within the interior of the build box and cause an outflow of exhaust from the build box.
